(19) United States
(12) Patent Application Publication
(10) Pub. No.: US 2012/0216403 A1
(43) Pub. Date: Aug. 30, 2012

(54) LOADING ELEMENT

(75) Inventors: David Thomson, Hamilton Queensland (AU); Jonathan Salmon, Makati City (PH)

(73) Assignee: ITI SCOTLAND LIMITED, Glasgow (GB)

(21) Appl. No.: 13/387,478

(22) PCT Filed: Jul. 27, 2010
(86) PCT No.: PCT/EP10/60883

§ 371 Date: May 15, 2012

(30) Foreign Application Priority Data
Jul. 29, 2009 (GB) 0913228.3

(51) Int. Cl. B21D 51/16; B23P 21/00

(52) U.S. Cl. 29/890.09; 29/801

(57) ABSTRACT

The present invention provides a loading element for reversibly coupling a microfluidic or nanofluidic cartridge to a processing apparatus wherein the loading element comprises:
(a) a first connector part comprising a first set of air inlet ports and a first set of air outlet ports;
(b) a second connector part comprising a second set of air inlet ports and a second set of air outlet ports; and
(c) a guide part configured to guide the cartridge into reversible coupling with the loading element.

### FIELD OF THE INVENTION

The present invention concerns a loading element for reversibly coupling a microfluidic or nanofluidic device to a processing apparatus which is able to control analytical processes conducted on samples within the device.

### BACKGROUND OF THE INVENTION

Conventional medical assays require one or more samples (such as blood or urine samples) to be taken from a patient in a hospital, or in a doctor's surgery, and then transferred to a laboratory for analysis. In the past, analysis of a sample in a “central” laboratory was unavoidable, due to the size and complexity of assay devices and systems. However, the requirement to analyse the sample in a remote location causes significant delay in diagnosing and treating a patient. In order to reduce the delay, there is an ongoing need to develop assay systems and methods that can be carried out in the near-patient environment (at the point of care) and that provide results quickly.

It has been known for some time to employ microfluidic cartridge arrangements in biological assay systems. Cartridges are advantageous in that they allow use of a single generalised assay device to assay for a number of different analytes by employing a different cartridge for each different analyte. They also simplify the assay procedure, in comparison with larger, more cumbersome laboratory systems. The development of microfluidic processing devices and chips has facilitated the development of such cartridges, since microfluidics allows much smaller (and cheaper) cartridges to be produced which can readily be inserted into a larger robust assay device.

Document US 2004/0086872 describes a system for microfluidic processing and/or analysis of nucleic acid in a sample which utilises a cartridge arrangement. In particular, the system comprises a cartridge configured to receive the sample, and a control apparatus that interfaces electrically with the cartridge. In particular, US 2004/0086872 indicates that the cartridge is at least partially inserted into the control apparatus and the control apparatus includes a recess that matingly receives the cartridge. Coupling is achieved through an electrical interface formed through contact between electrical contact pads on the cartridge and corresponding contact structures positioned in the recess. The control apparatus may include one or more electronically controlled mechanical interfaces to provide or regulate pressure on the cartridge.

Document U.S. Pat. No. 6,989,130 discloses an alternative automated fluidic system that detects a particular protein in a biological sample by enzyme-linked immunosorbent assay (ELISA). The system includes a plurality of reservoirs, including a sample reservoir, a dye reservoir and a number of control reservoirs, each reservoir having a hydrophobic upper barrier connected to a compressed-air inlet and a hydrophobic lower barrier connected to a liquid outlet, and a cartridge with microfluidic channels. The cartridge is designed to be detachable from the automated fluidic system.

However such systems are relatively limited in the range of assays/analytical tests that they can perform and therefore they do not fully meet the needs of an assay system for the near-patient environment. It is the aim of the present invention to address this issue and to provide parts of an apparatus and an apparatus which can be used to conduct a broader range of assays on biological samples.

### SUMMARY OF THE INVENTION

Accordingly, the present invention provides a loading element for reversibly coupling a microfluidic or nanofluidic cartridge to a processing apparatus wherein the loading element comprises:
(a) a first connector part comprising a first set of air inlet ports and a first set of air outlet ports;
(b) a second connector part comprising a second set of air inlet ports and a second set of air outlet ports; and
(c) a guide part configured to guide the cartridge into reversible coupling with the loading element.

In particular, the loading element is arranged such that only dry connections are formed with the cartridge.

The present inventors have found that a loading element as describe above is advantageous since it can be used in combination with disposable microfluidic or nanofluidic devices to enable a processing apparatus to conduct a variety of analytical tests on a sample within the device. Further, the element allows dry connections to be maintained between the disposable microfluidic or nanofluidic device and the processing apparatus. The processing apparatus is therefore quickly re-usable without the need for cleaning or decontamination steps between the running of different assays on different disposable devices.

The present invention also provides a processing apparatus comprising the loading element as described herein and at least one control element for controlling processes on the cartridge when the cartridge is coupled to the loading element.

Further the present invention provides a method of assembly comprising aligning a microfluidic or nanofluidic cartridge comprising a plurality of air inlet ports with a loading element as described herein using the guide part of the loading element, and applying pressure to couple the outlet ports of the loading element with inlet ports of the cartridge.

In addition, the present invention provides an assay method conducted within a microfluidic or nanofluidic cartridge coupled to the loading element of a processing apparatus as described herein, the assay method comprising:
(a) providing pressurised air to the cartridge through the first set of air outlet ports of the loading element to move at least one liquid within the cartridge, and
(b) providing pressurised air to the cartridge through the second set of air outlet ports of the loading element to achieve actuation of at least one valve within the cartridge,
   wherein step (a) and step (b) are controlled by the at least one control element of the processing apparatus.

### DETAILED DESCRIPTION OF THE INVENTION

The present invention will now be described further by way of example only with reference to the accompanying figures, in which:

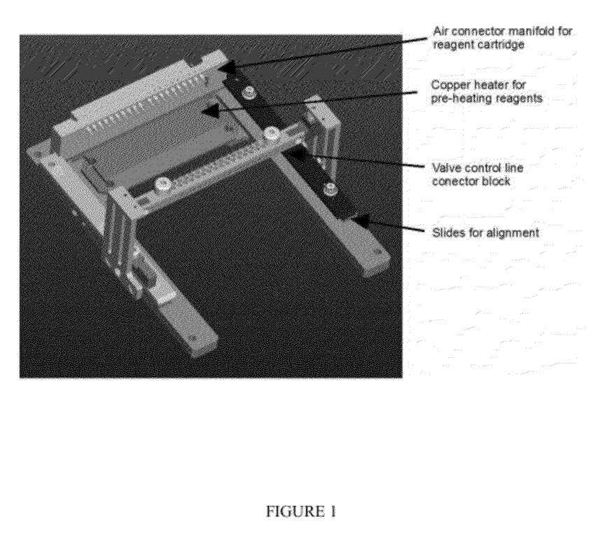

FIG. 1 provides an illustration of an example of the loading element of the present invention.

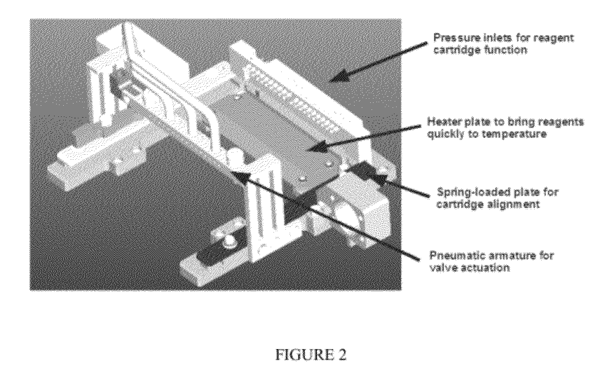

FIG. 2 provides an illustration of a further example of the loading element of the present invention.

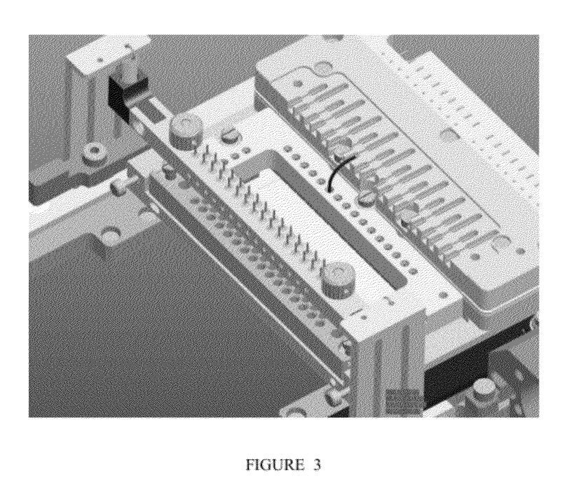

FIG. 3 provides an illustration of an example of the loading element of the present invention, into which a cartridge has been loaded.

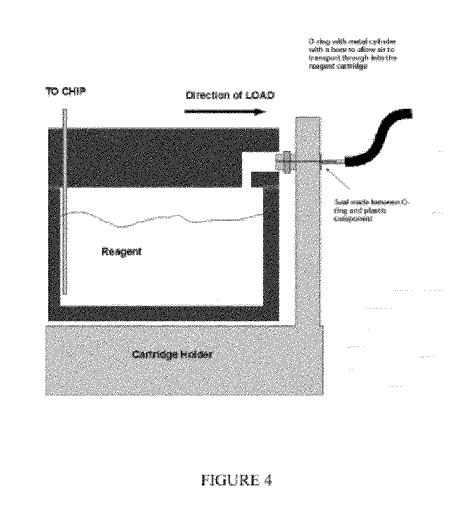

FIG. 4 shows an example of the connection between one outlet port of the loading element and one inlet port of the cartridge.

As indicated above the present invention relates to a loading element for reversibly coupling a microfluidic or nanofluidic device, such as a cartridge, to a processing apparatus. The loading element comprises a first and a second connector part or manifold. These parts have a plurality of inlet ports and a plurality of outlet parts. The outlet ports are arranged to be connected to the inlet ports of the cartridge when it is coupled to the loading element. The inlet ports are arranged to be connected to a compressed air supply or source and/or a vacuum source.

Preferably the first and/or the second connector parts comprise at least fifteen outlet ports. More preferably the first and/or second connector parts comprise at least thirty outlet ports.

In particular, the outlet ports of the first connector part are arranged to provide compressed air which will push or force liquid through the microfluidic/nanofluidic channels or chambers of the cartridge. Thus these ports are arranged to connect directly with the liquid containing parts of the cartridge, in a manner shown, for example, in FIG. 4.

In a preferred aspect of the invention the loading element enables a dry connection to be formed with the cartridge, such that liquids contained within the cartridge, for example reagents or a biological sample, are not transferred into the loading element. This may be achieved by using a cartridge with a small inlet port, such that the surface tension of the liquid in the cartridge is sufficient to prevent it from moving backwards into the inlet port of the cartridge and further into the outlet port of the loading element. Accordingly, the opening in the outlet port of the loading element may be of a similar size, i.e. sufficiently small in diameter to prevent a liquid having a surface tension of between 20 to 500 dyne cm⁻¹, preferably between 50 to 100 cm⁻¹, from moving into the opening. Preferably the opening in the outlet port is less than 150 μm in diameter and most preferably less than 50 μm in diameter.

Alternatively, or in addition, one or more hydrophobic membranes can be utilised within the outlet ports of the loading element to prevent reverse fluid flow. Similarly, the loading element can be used with cartridges with hydrophobic membranes positioned within the inlet ports. Suitable hydrophobic membranes, which allow only air to pass through, are known in the art.

Further, the cartridge used with the loading element may be designed so that there is no possibility of reverse fluid flow

Further, as shown in FIG. 4, the output ports of the first and second connector parts can comprise a cylinder surrounded by an O-ring to seal the connection between the loading element and the cartridge.

The outlet ports of the second connector part are arranged to provide compressed air and/or a vacuum to achieve actuation of valves contained within the microfluidic or nanofluidic cartridge. In a preferred aspect of the invention the loading element comprises an armature extending above the first connector part on which the second connector part is arranged.

Examples of this aspect of the invention are shown in FIGS. 2 and 3, where the guide part is a rectangular plate arranged substantially at right angles to the first connector part. In one aspect of the invention the armature is moveable. In one embodiment of this aspect the armature may be lowered into position once the cartridge has been connected to the first connector part.

The loading element further comprises one or more guide parts, which are configured to guide the cartridge into reversible coupling with the loading element. Examples of guide parts are shown in FIGS. 1 and 2. In particular, the guide part may be a rectangular part or plate along which the cartridge can be slid into position. In a preferred embodiment the guide part is a spring-loaded plate. The purpose of the guide part is to ensure that the alignment and coupling of the cartridge with the loading element is as simple as possible so as to avoid the need for a skilled operator. Thus the cartridge can be coupled to the loading element through the steps of aligning the cartridge to the loading element using the guide part, and applying pressure to couple the outlet ports of the loading element to the inlet ports of the cartridge. In one embodiment of the present invention these steps are automated. For example, these steps can be undertaken by a mechanical arm which forms part of the processing apparatus to which the loading element is attached.

The material from which the connector parts and guide part(s) is made is not particularly limited. However, they are preferably manufactured from a thermoplastic, aluminium and/or stainless steel may also be used.

In another embodiment of the present invention the loading element further comprises a heating element. This can take any form but is usually a heating plate which contacts the cartridge when the cartridge is coupled to the loading element. The heating element can therefore be used to alter the temperature of the reagents/sample within cartridge, and particularly those in chambers or channels situated close to the surface of the cartridge. As shown in FIGS. 1 and 2 the heating plate is preferably arranged below the first connector part so that the cartridge rests on the plate when connected to the loading element.

In one aspect of the present invention the loading element further comprises a plurality of electrical contacts configured to couple with electrical contacts on the processing apparatus to facilitate or control the manner in which the pressurised air and/or vacuum is applied through the outlet ports to the cartridge. Alternatively, control of the supply of pressurised air and/or vacuum through the loading element to the cartridge is remote from the loading element and the element simply acts as a conduit for the pressurised air and/or vacuum.

The loading element described herein is designed for use with microfluidic or nanofluidic devices, such as disposable microfluidic or nanofluidic cartridges, which are not the subject of the present invention. Microfluidic and nanofluidic devices are well known in the art, and are designed to manipulate fluids (liquids and/or gases) that are constrained in the microscale or nanoscale respectively. Microfluidic and nanofluidic devices have been used in many different fields which require the use of very small volumes of fluids, including engineering and biotechnology. Suitable microfluidic and nanofluidic cartridges which can be used in the present invention are known in the art. In particular, it is preferred that the cartridge used is one as described in WO 2008/037995.

The present invention further comprises a processing apparatus comprising the loading element of the invention and at least one control element for controlling processes within the cartridge when the cartridge is coupled to the loading element. In particular, the loading element enables a microfluidic or nanofluidic device to be easily joined to the processing apparatus. The control element sends and receives electrical signals so that the processing apparatus is capable of controlling the air applied to the cartridge through the ports of the loading element, and, as a result, is capable of controlling the processes occurring within the cartridge.

Accordingly, the present invention also provides an assay method conducted within a microfluidic or nanofluidic cartridge coupled to the loading element of a processing apparatus as described herein, the assay method comprising:
(a) providing pressurised air to the cartridge through the first set of air outlet ports of the loading element to move at least one liquid within the cartridge, and
(b) providing pressurised air to the cartridge through the second set of air outlet ports of the loading element to achieve actuation of at least one valve within the cartridge,
   wherein step (a) and step (b) are controlled by the at least one control element of the processing apparatus.

The types of assays which may be performed using the processing apparatus are not particularly limited. Accordingly, the assays may be for screening, purifying, identifying, capturing and/or quantifying any type of substance and in particular any type of biological substance which may be present in the sample within the cartridge. Example assays are nucleic acid assays, enzyme assays, protein assays or small molecule assays.

### EXAMPLES

Specific examples of embodiments of the loading element of the invention are shown in FIGS. 1 to 3. In these embodiments the loading element is arranged with the first and second connector parts in parallel. When the loading element is empty (i.e. without a cartridge inserted) the second connector part (the valve control line connector block) is raised above the level of the first connector part (the air connector manifold for reagent cartridge). The guide part, as shown in FIGS. 1 and 2, comprises a slide which is a rectangular part arranged substantially at right angles to the first connector part, which acts to guide the cartridge into position so that the outlet ports of the first connector part connect with the inlet ports of the cartridge. As indicated in FIG. 2 this plate is spring loaded to assist the connection between the loading element and the cartridge.

In the examples shown in FIGS. 1 and 2 the loading element further comprises a copper heater plate positioned at the base of the first connector part. When the cartridge has been loaded onto the loading element it rests on the heater plate allowing reagents within the cartridge to be heated.

As shown in FIG. 3 the armature of the second connector part comprises a spring, allowing the second connector part to be raised and lowered for connection to the cartridge.

A connection between the loading element (or cartridge holder) and the cartridge is shown in FIG. 4. The inlet port of the cartridge is pressed onto the outlet port of the loading element. An O-ring positioned around the outlet port of the loading element ensures that the connection is sealed. In particular, the outlet port is shown as comprising a metal cylinder with a central bore to allow pressurised air and/or a vacuum to be applied to the cartridge. In the embodiment shown in FIG. 4 the inlet valve of the first connector part is connected via a flexible hose or pipe to the pressurised air or vacuum supply.

1. A loading element for reversibly coupling a microfluidic or nanofluidic cartridge to a processing apparatus wherein the loading element comprises:
(a) a first connector part comprising a first set of air inlet ports and a first set of air outlet ports;
(b) a second connector part comprising a second set of air inlet ports and a second set of air outlet ports; and
(c) a guide part configured to guide the cartridge into reversible coupling with the loading element.

2. A loading element according to claim 1 further comprising a plurality of electrical contacts configured to couple with electrical contacts on the processing apparatus.

3. A loading apparatus according to claim 1, wherein the first set of air outlet ports are to provide pressurised air to the cartridge for liquid pumping.

4. A loading apparatus according to claim 1, wherein the second set of air outlet ports are to provide pressurised air to the cartridge for valve actuation.

5. A loading element according to claim 1, wherein the guide part comprises a spring loaded plate which enables the cartridge to be aligned with the loading element during coupling.

6. A loading element according to claim 1, which comprises an armature extending above the first connector part on which the second connector part is arranged.

7. A loading element according to claim 1, which further comprises a heating element.

8. A loading element according to claim 7 wherein the heating element is a heated plate arranged to contact a surface of the cartridge when the cartridge is reversibly coupled to the loading element.

9. A loading element according to claim 1, which further comprises at least one electrical contact configured to couple with at least one electrical contact on the cartridge.

10. A loading element according to claim 1, wherein the outlet ports enable a dry connection to be formed with the cartridge.

11. A loading element according to claim 1, wherein the first and/or second connector parts comprises as least fifteen outlet ports.

12. A loading element according to claim 11 wherein the first and/or second connector parts comprise at least thirty outlet ports.

13. A processing apparatus comprising the loading element according to claim 1, and at least one control element for controlling processes on the cartridge when the cartridge is coupled to the loading element.

14. A processing apparatus according to claim 13, further comprising a microfluidic or nanofluidic cartridge reversibly coupled to the loading element.

15. A processing apparatus according to claim 13, further comprising a pressurised air supply connected to the inlet ports of the first and second connector parts.

16. A processing apparatus according to claim 13, comprising at least two control elements and a transport means capable of bringing the cartridge when coupled to the loading element into communication with the at least two control elements.

17. A method of assembly comprising aligning a microfluidic or nanofluidic cartridge comprising a plurality of air inlet ports with a loading element according to claim 1 using the guide part of the loading element and applying pressure to couple the outlet ports of the loading element with the inlet ports of the cartridge.

18. A method of assembly according to claim 17 wherein the steps of aligning and applying pressure are conducted by a robot arm.

19. An assay method conducted within a microfluidic or nanofluidic cartridge coupled to the loading element of a processing apparatus according to claim 13, the assay method comprising:
(a) providing pressurised air to the cartridge through the first set of air outlet ports of the loading element to move at least one liquid within the cartridge, and
(b) providing pressurised air to the cartridge through the second set of air outlet ports of the loading element to achieve actuation of at least one valve within the cartridge,
wherein step (a) and step (b) are controlled by the at least one control element of the processing apparatus.
